(19) United States
(12) Patent Application Publication
(10) Pub. No.: US 2024/0391686 A1
(43) Pub. Date: Nov. 28, 2024

(54) BEVERAGE OR FOODSTUFF PREPARATION SYSTEM

(71) Applicant: SOCIETE DES PRODUITS NESTLE S.A., Vevey (CH)

(72) Inventors: CHIARA PAVAN, Vullierens (CH); GILLES GERBER, Penthaz (CH)

(21) Appl. No.: 18/696,813

(22) PCT Filed: Sep. 27, 2022
(86) PCT No.: PCT/EP2022/076814

§ 371 Date: Mar. 28, 2024

(30) Foreign Application Priority Data
Sep. 30, 2021 (EP) 21200316.4

(51) Int. Cl. B65D 85/804; A47J 31/40; A47J 31/52

(52) U.S. Cl. CPC B65D 85/8043; A47J 31/407; A47J 31/52

(57) ABSTRACT

A container for use with a machine for preparing a beverage and/or foodstuff or a precursor thereof, the container including: a storage portion comprising a cavity with a base for containing a precursor material, and; a closing member to close the storage portion, at least a base region of the storage portion is formed of a wood pulp based material, wherein the storage portion includes stiffener portions, which are disposed to stiffen the base to resist displacement when the base is perforated by a penetrator of the machine.

### TECHNICAL FIELD

The present disclosure relates to electrically operated beverage or foodstuff preparation systems, with which a beverage or foodstuff is prepared from a pre-portioned capsule.

### BACKGROUND

Systems for the preparation of a beverage comprise a beverage preparation machine and a capsule. The capsule comprises a single-serving of a beverage forming precursor material, e.g. ground coffee or tea. The beverage preparation machine is arranged to execute a beverage preparation process on the capsule, typically by the exposure of pressurized, heated water to said precursor material. As part of this preparation process, the capsule is guided through the machine by a series of complex interactions to load, process and eject the capsule, by various mechanisms of the machine and principally a flange portion of the capsule. Processing of the capsule in this manner causes the at least partial extraction of the precursor material from the capsule as the beverage.

This configuration of beverage preparation machine has increased popularity due to enhanced user convenience compared to conventional beverage preparation machines (e.g. compared to a manually operated Moka pot/stove-top espresso maker).

Due to the complex movement of the capsule through the machine and the exposure to pressurized, heated water, to date only an aluminium based capsule has been implemented with a high degree of reliability. Indeed, other materials have been found to be prone to sticking in the machine or cause other material related errors. It would be desirable to be able to implement the capsule with less of a materials restriction.

Therefore, in spite of the effort already invested in the development of said capsule further improvements are desirable.

### SUMMARY

The present disclosure provides a container for use with a machine for preparing a beverage and/or foodstuff or a precursor thereof, the container including: a storage portion comprising a cavity with a base for containing a precursor material, and; a closing member to close the storage portion.

In embodiments, at least part of the storage portion is formed of a wood pulp based material, wherein the wood pulp based material includes a perforation region, which is treated to facilitate comparatively easier perforation by a penetrator of the machine than a portion that is not treated.

By treating a wood pulp-based container so that it is more easily perforated a reliability of such containers when used in the machine may be improved. For example, a condition where a wood pulp based capsule has absorbed water at the perforation region causing it to deform with the penetrator rather than be perforated by the penetrator may be minimised or a condition where a large force/amount of energy is required, e.g. due to delamination/debonding of the fibres of the wood pulp, may be minimised.

As used herein the term “perforation region” may refer to a region that is directly abutted by the penetrator, e.g. a wetted area of/area overlapped by a section in the longitudinal and lateral plane on the penetrator prior to penetration.

As used herein the term “comparatively easier” in respect of perforation by the penetrator may refer to one or more of: a perforation of the perforation region that comprises a more brittle type failure mode with comparatively lower energy absorption rather than a ductile type failure mode with comparatively higher energy absorption of an untreated region; less displacement of the penetrator to achieve full penetration (e.g. due to a reduced thickness of the perforation region and/or less movement of the perforation region with the penetrator) and; a penetration with a lower maximum force.

In embodiments, the perforation region includes one or more of the following material properties compared to a portion that is not treated: reduced water absorbency; increased brittleness (e.g. characterised by a more brittle type fracture with low energy absorption); increased stiffness, and; reduced thickness.

As used herein the term “water absorption” may refer to an amount, e.g. in grammes, of water absorbed per unit area, e.g. in m² of the wood pulp based material for a given time, e.g. 60 or 180 seconds. Examples of suitable tests include Cobb60 or Cobb180 tests. By implementing a perforation region with reduced water absorption the perforation region may be easier to penetrated than if waterlogged since a waterlogged portion may expand thus requiring more displacement to fully penetrate and be more likely to displace with the penetrator rather than be penetrated.

In embodiments, the perforation region is treated by one or more of the following processes: pressing; heat treatment; applying a coating, and; scoring.

As used herein the term “heat treatment” may refer to an application/extraction of thermal energy as part of the treatment process. Typically heat treatment includes increasing a temperature of the wood pulp-based material. In embodiments, the temperature may be 100-300 or 100 to 400 degrees C.

As used herein the term “pressing” may refer to the application of a compressive force in the through-thickness direction of the wood pulp-based material to reduce a thickness. In embodiments, the pressure may be 1×10⁵-1×10⁷ Pa or 1×10⁴-1×10⁸ Pa.

In embodiments, the heat treatment and/or pressing may be applied for 2-10 seconds.

As used herein the term “applying a coating” may refer to the application of a coating to the wood pulp based material to close pores/interstices between the fibres and/or to act as a barrier. This may provide reduced water absorption, which may be advantageous for the reasons previously given. This may also provide a more brittle type failure, which may be advantageous for the reasons previously given. The coating may comprise caramelised sugar or starch or other suitable coating.

In embodiments, the perforation region has a reduced thickness by at least 20% or 30% or 35% compared to a portion that is not treated. For example, a 0.5 mm thick material may have the thickness reduced to 0.3 mm thickness. In embodiments, a maximum thickness reduction may be 60 to 70%.

In embodiments, the perforation region is arranged at a base of a cavity of the storage portion.

In embodiments, the perforation region is arranged as an annular ring which is central about an axis of rotation of the container. An annular ring may be convenient to form by a shaped press. Moreover, it may be ensured that a penetrator composed of discreet penetration elements that are arranged about the axis of rotation of the container has an element always aligned with a portion annular ring.

In embodiments, the annular ring is arranged as segments, which are bounded by bridges that are not treated. By implementing bridges that bound the segments an overall strength of the base may be maintained since force between an inside of the annular ring can be transmitted principally via the bridges, rather than entirely through the brittle segments.

In embodiments, the bridges are arranged to have a different angular pitch compared to an angular pitch of penetration elements forming the penetrator of the machine. By implement the angular pitch to be different, even if one penetration element happens to be aligned to a bridge, others will not, hence it may be ensured that at least one penetration element entirely penetrates a segment of the perforation region rather than a bridge.

In embodiments, the perforation region is configured to be perforated by a penetrator elements with a total area of 6-15 mm² when subject to at least 2-10 Newtons or 0.5-50.

In embodiments, at least the base and/or the sidewalls (or all) of the storage portion is formed of a wood pulp-based material. In embodiments, the wood pulp-based material has a thickness of 0.25 mm to 0.75 mm (e.g. for a region that is not treated).

In embodiments, at least part of the container is formed of a wood pulp-based material, wherein the wood pulp-based material includes a treatment region. In embodiments, the treatment region is treated to glassify the wood pulp-based material (e.g. by the application of pressure and heat as disclosed herein). In embodiments, the treatment region is located on a lower surface of a flange portion of the container. The treatment region may enable a narrower flange than for an untreated wood pulp-based material, which is comparable in thickness to a flange formed of conventional materials (e.g. aluminium) of an conventional container. This may enable the container to be compatible with machines designed for conventional containers. The treatment region may also provide a more consistent (e.g. smoother with reduced discontinuities) surface to receive a code.

In embodiments, at least a base region of the storage portion is formed of a wood pulp based material, wherein the storage portion includes stiffener portions, which are disposed to stiffen the storage portion (e.g. the base, or more particularly a perforation region of the base) to resist displacement (e.g. compared to an equivalent container without the stiffener portions) when the base is perforated by a penetrator of the machine.

By implementing stiffener portions in combination with a wood pulp based material for the base, it may be ensured that the wood pulp based base is cleanly penetrated by a penetration of the machine when performing the container to form one or more fluid inlets for injection of conditioned fluid to form a beverage.

As used herein the term “displacement” may refer to a depth (or other component of displacement) of the base when the penetrator is moved through the base in the depth direction. It will be understood that the base is required to resist displacement so that it does not displace/is minimally displaced locally by the penetrator such that it remains relatively undeformed as the penetrator is moved therethough. It will also be understood that a perforation region is required to fracture/crack rather than displace.

As used herein the term “base” may refer to a portion of the container that forms the lowest surface of the cavity, and which closes sidewalls. The base may have a lateral and longitudinal component (or a radial component) that is greater than a depth component.

As used herein the term “sidewall” may refer to a portion of the container that is arranged between the base and the flange portion. The sidewall may have a principal component in the depth direction.

As used herein the term “base region” may refer to a portion of the container that includes the base and a proximal portion of the sidewall adjoining the base. Proximal and distal are defined herein as relative the base. Hence a proximal portion refers to a portion of the sidewall in immediate proximity to the base. The stiffener portions can be located on a portion of the sidewalls that significantly effects the rigidity of the base. The base region may include a portion of the sidewall that has a distance d, which is measured from the lowest position of the base in the depth direction, that is less than 50% or 40% of the total depth D, which is measured from said lowest position of the base to a top of the flange portion.

As used herein the term “stiffener portion” may refer to a portion of the wood pulp based material that is geometrically adapted from a regular shape of the container to provide increased stiffness of the base. The stiffness of the base may be determined based one or more of: a rigidity (e.g. a Youngs modulus) of the base region itself, including the stiffness of the base and/or the sidewall; a structural constraint at a joining of the base and sidewall that provides a more rigid support for the base. The stiffener portion may be formed from the same wood pulp based material as the rest of the base region, including in composition and thickness.

As used herein the term “resist displacement” may refer to the base itself being stiffer so that it displaces, e.g. flexes, less when impacted by a penetrator. It may also refer to the sidewalls being less likely to buckle (or otherwise displace) and therefore the base resisting displacement based of reduced buckling of the sidewalls.

In embodiments, the stiffener portions are arranged to extend over both the base and the proximal region of the side wall. By arranging the stiffener portions to extend continuously over the base and side wall, they may provide enhanced stiffness increases.

In embodiments, the stiffener portions protrude into the interior of the storage portion and may not outwardly from the exterior. By implementing the stiffener portions so that their geometric formations are entirely formed within the container (e.g. no portion of the stiffener portion extends beyond the profile of the container (compared an equivalent portion of the container that does not include the stiffener portion), existing machines may be compatible with the new and inventive configuration of capsule.

In embodiments, the stiffener portions are arranged as channels that bridge the base and proximal region of the side wall. By arranging the channels to interconnect portions of the sidewall and base that are not interconnected compared an equivalent portion of the container that does not include the stiffener portion, the rigidity may be improved.

In embodiments, a base of the channels is linear. A linear base of the channel may provide improved buckling/displacement resistance. The channel may have a V-shaped, U-shaped or other suitably shaped section.

In embodiments, the channels are radially aligned. By implementing the channels to be radially aligned, such that the base of the channel extends with a combined lateral and longitudinal component aligned to the radial direction, improved buckling/displacement resistance may be provided.

In embodiments, the stiffener portions have a maximum channel depth X of less than 10 mm and greater than 2 mm or less than 8 mm and greater than 4 mm. The channel depth X may be defined as a perpendicular distance from a base of the channel to a virtual line for a section that does not comprise a stiffener portion. With such a range the channels may provide enhanced stiffness.

In embodiments, the stiffener portions are arranged to extend in a depth direction along the sidewall by a distance Y from the junction with the base (e.g. at a virtual location of the junction when measured for an equivalent portion of the container that does not comprise a stiffener portion) to a depth of less than 40% or 30% of the total depth D between the storage portion and base. Distance Y may be at least 5 or 10%. With such a range the stiffener portions may provide enhanced stiffness.

In embodiments, the stiffener portions are arranged to extend along the base from a periphery of the base to a radii Z of greater than 30% or 40% of the total radii R of the base. With such a range the stiffener portions may provide enhanced stiffness.

In embodiments, the stiffener portions are arranged to extend along the base from a periphery to contiguous a perforation region that is perforated by a penetrator of the machine. By arranging the stiffener portions to be highly proximal the perforation region, they may provide high structural support to a portion of the base that is perforated.

As used herein the term “contiguous” may refer to exactly adjoining or in close proximity (e.g. within 4 or 2 or 1 mm). As used herein the term “perforation region” may refer to a region that is directly abutted by the penetrator, e.g. a wetted area of/area overlapped by a section in the longitudinal and lateral plane on the penetrator prior to penetration.

In embodiments, the stiffener portions are arranged to prevent a perforation region of the base displacing (e.g. an average displacement for the whole perforation region) by more than 0.5-2 mm in a depth direction, when the perforation region is subject to a compressive force in the depth direction of 1-50 N or 2-10 N, which is applied by the penetrator.

In embodiments, the stiffener portions comprise discrete units (e.g. that are separate from each other) that are circumferentially disposed about a circumference of the container. An undulating arrangement of equally spaced stiffener portions may provide increase stiffness.

In embodiments, the stiffener portions are arranged only on the base or on the sidewall.

In embodiments, the storage portion comprises the cavity with sidewalls, and; a flange portion to interconnect the storage portion and the closing member, wherein the sidewalls comprise a shoulder proximal the flange portion that extends outwardly (e.g. away from an interior of the cavity) to define a void defining region of the sidewall that is arranged between the shoulder and the base the shoulder arranged to engage a container holding portion of a processing unit of the machine with the void defining region arranged distal the container holding portion to form a void therebetween. In some other embodiment, the sidewalls comprise a shoulder proximal the base portion that also define a void defining region of the sidewall.

By implementing a shoulder at a top of the storage portion, the shoulder can engage the container holding portion to precisely position a void defining region of the sidewall away from and adjacent part of the container holding portion, hence to define a void between the sidewall and the container holding portion. This void may help to reduce the container sticking in the container holding portion during processing of the container, particularly when the container is formed of a wood pulp based material and is more susceptible to displacing.

As used herein the term “shoulder” may refer to a portion of the sidewall that projects in a longitudinal and/or lateral direction (e.g. outwardly in the radial direction) from a remainder of the sidewall as a step, chamfer or otherwise.

As used herein the term “proximal” in respect of a position of the shoulder and the flange portion may refer to the shoulder being arranged to directly adjoin the flange portion, or being in close proximity of e.g. within 1 or 2 mm in a depth direction.

As used herein the term “void region” may refer to a region of the sidewall that is arranged in use to be separate, i.e. distal, from the container holding portion.

In embodiments, the shoulder extends from the flange portion to a rim of the sidewall (e.g. a step or a chamfer or a curved or other shaped discontinuity in the outer surface profile). An entirety of the shoulder (e.g. in terms of depth and/or circumference) between the flange portion and rim of the side wall may engage the container holding portion. Such an arrangement may provide high stability in spite of the void.

In embodiments, the shoulder has a depth distance S between the flange portion and a rim of the sidewall of less than 70% or 60% or 50% or 40% or 30% or 25% or 20% of the total depth D of the storage portion, which may be measured from said lowest position of the base to a top of the flange portion. In embodiments, the shoulder has a depth distance S between the flange portion and rim of greater than 5% or 10% or 15% of the total depth D of the storage portion. By having the shoulder within such a % depth range a sufficient level of stability may be provided in spite of the void.

In embodiments, the void defining region of the sidewall extends in the depth direction and/or circumferential direction from the shoulder (e.g. including entirely) to the base of the container. By implementing the container so that no other portion of the sidewall than the shoulder is in contact with the container holding portion, it may be ensured that the container is less likely to stick in the container holding portion.

In embodiments, the void defining region of the sidewall is arranged to have a separation distance N in a radial direction from the container holding portion of at least 0.5 mm and/or less than 5 mm.

By ensuring a minimum separation of the void defining region and the sidewall of this amount the container may be less likely to stick in the container holding portion.

In embodiments, an average of the separation distances N between the void defining region of the sidewall and the container holding portion is at least 0.5 mm or 1 mm. By ensuring an average separation of the void defining region and the sidewall of this amount the container may be less likely to stick in the container holding portion.

In embodiments, the container is arranged to be stacked within a second corresponding (e.g. in shape) container, whereby a rim of the shoulder of the container engages the flange portion of the second container and at least part of the void defining region of the sidewall of the container is distal an interior of a cavity of the second container. With such an arrangement, containers prior to filling may be stacked with reduced sticking.

In embodiments, the stiffener portions of any preceding embodiment or another embodiment disclosed herein is implemented in combination with the shoulder to stiffen the void defining region of the sidewall. By implementing the stiffener portions to stiffen the void defining region of the sidewall, a reduced stability of the sidewall due to it not being in contact with the container holding portion, and therefore being stabilized by said portion, may be compensated for.

In embodiments, the stiffener portions protrude into an interior of the storage portion and not outwardly from an exterior thereof. By implementing the stiffener portions to protrude into an interior of the cavity of the storage portion, the void region may be maintained around the stiffener portions to reduce sticking. In embodiments, the stiffener portions are arranged as channels that bridge the base and the void defining region of the side wall. By arranging the stiffener portion to interconnect the void defining region of the side wall and the base, a stability of the void defining region may be increased.

The present disclosure provides a system comprising a container of any preceding embodiment or another embodiment disclosed herein and a machine for preparing a beverage and/or foodstuff or a precursor thereof. In embodiments, the machine includes: a processing unit for processing the precursor material of the container, and; electrical circuitry to control the processing unit.

The present disclosure provides, use of the container of any preceding embodiment or another embodiment disclosed herein for a machine as discussed herein.

The present disclosure provides a method of preparing a beverage and/or foodstuff or a precursor thereof. The method may be implemented with any preceding embodiment or another embodiment disclosed herein. The method comprises: perforating with an penetrator of said machine a perforation region, which is treated to facilitate comparatively easier perforation by the penetrator of the machine than a portion that is not treated and; processing the precursor material.

In embodiments, processing the precursor material includes one or more of the following processes: injecting conditioned fluid into the container via inlets at the perforation region in a base of the container formed by the machine; increasing a pressure of fluid in the container until a rupturing portion of the container ruptures to provide the beverage, and; ejecting a spend container from the container processing unit.

The present disclosure provides a method of forming a container for use with a machine for preparing a beverage and/or foodstuff or a precursor thereof. The method may be implemented with any preceding embodiment or another embodiment disclosed herein. The method comprises: processing a perforation region of the container that is formed of a wood pulp based material to facilitate comparatively easier perforation by a penetrator of the machine than a portion that is not treated. In embodiments, the method comprises: forming a storage portion of the container, and subsequently; processing the storage portion to implement the perforation region.

The present disclosure provides a method of preparing a beverage and/or foodstuff or a precursor thereof. The method may be implemented with any preceding embodiment or another embodiment disclosed herein. The method comprises: penetrating a wood pulp based portion of a container with a penetrator to provide fluid inlets and resisting displacement of the wood pulp based portion during said penetration with stiffener portions, and; processing the precursor material.

In embodiments, processing the precursor material includes one or more of the following processes: injecting conditioned fluid into the container via inlets at a perforation region in a base of the container formed by the machine; increasing a pressure of fluid in the container until a rupturing portion of the container ruptures to provide the beverage, and; ejecting a spend container from the container processing unit.

The present disclosure provides a method of forming a container. The method may be implemented with any preceding embodiment or another embodiment disclosed herein. The method comprises: forming a storage portion of the container from a wood pulp based material, which may comprise wet forming, that may include hot pressing. The method may comprise forming the stiffening portions with the storage portion of subsequently.

The present disclosure provides a method of preparing a beverage and/or foodstuff or a precursor thereof. The method may be implemented with any preceding embodiment or another embodiment disclosed herein. The method comprises: arranging a container containing precursor material in a container holding portion of a processing unit of a machine; engaging a shoulder of a sidewall of the container that is profiled to maintain a void between a portion of the sidewall between a base and the shoulder, and; processing the precursor material.

In embodiments, processing the precursor material includes one or more of the following processes: injecting conditioned fluid into the container via inlets at a perforation region in a base of the container formed by the machine; increasing a pressure of fluid in the container until a rupturing portion of the container ruptures to provide the beverage, and; ejecting a spend container from the container processing unit. During one or all of said processes the void between the portion of the sidewall between a base and the shoulder and the container holding portion may be maintained.

The present disclosure provides a method of filling a container with precursor material. The method may be implemented with any preceding embodiment or another embodiment disclosed herein. The method comprises: arranging the container in a container holding portion of a filling machine; engaging a shoulder of a sidewall of the container that is profiled to maintain a void between a portion of the sidewall between a base and the shoulder, and; filling the container with the precursor material. The method may comprise ejecting a filled container from the filling machine. During one or all of said processes the void between the portion of the sidewall between a base and the shoulder and the container holding portion may be maintained.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Brief Description of Figures, and Claims.

### BRIEF DESCRIPTION OF FIGURES

Aspects, features and advantages of embodiments of the present disclosure will become apparent from the following detailed description of embodiments in reference to the appended drawings in which like numerals denote like elements.

FIG. 1 is a block system diagram showing an embodiment system for preparation of a beverage or foodstuff or a precursor thereof.

FIG. 2 is a block system diagram showing an embodiment machine of the system of FIG. 1.

FIG. 3 is an illustrative diagram showing an embodiment fluid conditioning system of the machine of FIG. 2.

FIGS. 4A and 4B are illustrative diagrams showing an embodiment container processing system of the machine of FIG. 2.

FIG. 5 is a block diagram showing embodiment control electrical circuitry of the machine of FIG. 2.

FIG. 6 is an illustrative diagram showing an embodiment container of the system of FIG. 1.

FIG. 7 is flow diagram showing an embodiment preparation process, which is performed by the system of FIG. 1.

FIGS. 8A and 8B are side views showing two possible embodiment storage portions of the container of FIG. 6.

FIGS. 9A and 9B are top views showing the storage portions of FIGS. 8A and 8B.

FIGS. 10A and 10B are side cross-sectional views showing the storage portion of FIGS. 9A and 9B though section lines A-A.

FIGS. 11A and 11B are bottom perspective views showing the storage portion of FIGS. 8A and 8B.

FIGS. 12A and 12B are top perspective views showing the storage portion of FIGS. 8A and 8B.

FIGS. 13A and 13B are side cross-sectional views showing respectively the cross-section of FIGS. 10A and 10B with a superimposed cross-section without a stiffener portion shown as a virtual section line.

FIGS. 14A and 14B are side cross-sectional views showing respectively the cross-section of the storage portion of FIGS. 10A and 10B and cross-section of a container holding portion of the system of FIG. 1.

FIGS. 15A and 15B are side cross-sectional views showing a portion of the storage portion of FIGS. 10A and 10B stacked with a corresponding container.

FIG. 16 is a top perspective view showing the storage portion of FIG. 8A.

### DETAILED DESCRIPTION OF EMBODIMENTS

Before describing several embodiments of the system, it is to be understood that the system is not limited to the details of construction or process steps set forth in the following description. It will be apparent to those skilled in the art having the benefit of the present disclosure that the system is capable of other embodiments and of being practiced or being carried out in various ways.

The present disclosure may be better understood in view of the following explanations:

As used herein, the term “machine” may refer to an electrically operated device that: can prepare, from a precursor material, a beverage and/or foodstuff, or; can prepare, from a pre-precursor material, a precursor material that can be subsequently prepared into a beverage and/or foodstuff. The machine may implement said preparation by one or more of the following processes: dilution; heating; pressurisation; cooling; mixing; whisking; dissolution; soaking; steeping; extraction; conditioning; infusion; grinding, and; other like process. The machine may be dimensioned for use on a work top, e.g. it may be less than 70 cm in length, width and height. As used herein, the term “prepare” in respect of a beverage and/or foodstuff may refer to the preparation of at least part of the beverage and/or foodstuff (e.g. a beverage is prepared by said machine in its entirety or part prepared to which the end-user may manually add extra fluid prior to consumption, including milk and/or water).

As used herein, the term “container” may refer to any configuration to contain the precursor material, e.g. as a single-serving, pre-portioned amount. The container may have a maximum capacity such that it can only contain a single-serving of precursor material. The container may be single use, e.g. it is physically altered after a preparation process, which can include one or more of: perforation to supply fluid to the precursor material; perforation to supply the beverage/foodstuff from the container; opening by a user to extract the precursor material. The container may be configured for operation with a container processing unit of the machine, e.g. it may include a flange for alignment and directing the container through or arrangement on said unit. The container may include a rupturing portion, which is arranged to rupture when subject to a particular pressure to deliver the beverage/foodstuff. The container may have a membrane for closing the container. The container may have various forms, including one or more of: frustoconical; cylindrical; disk; hemispherical, and; other like form. The container may be formed from various materials, such as metal or plastic or wood pulp based a combination thereof. The material may be selected such that it is: food-safe; it can withstand the pressure and/or temperature of a preparation process. The container may be defined as a capsule, wherein a capsule may have an internal volume of 20-100 ml. The capsule includes a coffee capsule, e.g. a Nespresso@ capsule (including a Classic, Professional, Vertuo, Dolce Gusto or other capsule).

As used herein, the term “external device” or “external electronic device” or “peripheral device” may include electronic components external to the machine, e.g. those arranged at a same location as the machine or those remote from the machine, which communicate with the machine over a computer network. The external device may comprise a communication interface for communication with the machine and/or a server system. The external device may comprise devices including: a smartphone; a PDA; a video game controller; a tablet; a laptop; or other like device.

As used herein, the term “server system” may refer to electronic components external to the machine, e.g. those arranged at a remote location from the machine, which communicate with the machine over a computer network. The server system may comprise a communication interface for communication with the machine and/or the external device. The server system can include: a networked-based computer (e.g. a remote server); a cloud-based computer; any other server system.

As used herein, the term “system” or “beverage or foodstuff preparation system” may refer to the combination of any two or more of: the beverage or foodstuff preparation machine; the container; the server system, and; the peripheral device.

As used herein, the term “beverage” may refer to any substance capable of being processed to a potable substance, which may be chilled or hot. The beverage may be one or more of: a solid; a liquid; a gel; a paste. The beverage may include one or a combination of: tea; coffee; hot chocolate; milk; cordial; vitamin composition; herbal tea/infusion; infused/flavoured water, and; other substance. As used herein, the term “foodstuff” may refer to any substance capable of being processed to a nutriment for eating, which may be chilled or hot. The foodstuff may be one or more of: a solid; a liquid; a gel; a paste. The foodstuff may include: yoghurt; mousse; parfait; soup; ice cream; sorbet; custard; smoothies; other substance. It will be appreciated that there is a degree of overlap between the definitions of a beverage and foodstuff, e.g. a beverage can also be a foodstuff and thus a machine that is said to prepare a beverage or foodstuff does not preclude the preparation of both.

As used herein, the term “precursor material” may refer to any material capable of being processed to form part or all of the beverage or foodstuff. The precursor material can be one or more of a: powder; crystalline; liquid; gel; solid, and; other. Examples of a beverage forming precursor material include: ground coffee; milk powder; tea leaves; coco powder; vitamin composition; herbs, e.g. for forming a herbal/infusion tea; a flavouring, and; other like material. Examples of a foodstuff forming precursor material include: dried vegetables or stock as anhydrous soup powder; powdered milk; flour based powders including custard; powdered yoghurt or ice-cream, and; other like material. A precursor material may also refer to any pre-precursor material capable of being processed to a precursor material as defined above, i.e. any precursor material that can subsequently be processed to a beverage and/or foodstuff. In an example, the pre-precursor material includes coffee beans which can be ground and/or heated (e.g. roasted) to the precursor material.

As used herein, the term “fluid” (in respect of fluid supplied by a fluid conditioning system) may include one or more of: water; milk; other. As used herein, the term “conditioning” in respect of a fluid may refer to changing a physical property thereof and can include one or more of the following: heating or cooling; agitation (including frothing via whipping to introduce bubbles and mixing to introduce turbulence); portioning to a single-serving amount suitable for use with a single serving container; pressurisation e.g. to a brewing pressure; carbonating; filtering/purifying, and; other conditioning process.

As used herein, the term “processing unit” may refer to an arrangement that can process precursor material to a beverage or foodstuff. It may refer to an arrangement that can process a pre-precursor material to a precursor material.

As used herein, the term “container processing unit” may refer to an arrangement that can process a container to derive an associated beverage or foodstuff from a precursor material. The container processing unit may be arranged to process the precursor material by one of more of the following: dilution; heating; cooling; mixing; whisking; dissolution; soaking; steeping; extraction; conditioning; pressurisation; infusion, and: other processing step. The container processing unit may therefore implement a range of units depending on the processing step, which can include: an extraction unit (which may implement a pressurised and/or a thermal, e.g. heating or cooling, brewing process); a mixing unit (which mixes a beverage or foodstuff in a receptacle for end user consumption therefore); a dispensing and dissolution unit (which extracts a portion of the precursor material and processes by dissolution and dispenses it into a receptacle), and: other like unit.

As used herein, the term “preparation process” may refer to a process to prepare a beverage or foodstuff from a precursor material or to prepare a pre-precursor material from precursor material. A preparation process may refer to the processes electrical circuitry executes to control the container processing unit to process said precursor or pre-precursor material.

As used herein, the term “electrical circuitry” or “circuitry” or “control electrical circuitry” may refer to one or more hardware and/or software components, examples of which may include: an application specific integrated circuit (ASIC); electronic/electrical componentry (which may include combinations of transistors, resistors, capacitors, inductors etc); one or more processors; a non-transitory memory (e.g. implemented by one or more memory devices), that may store one or more software or firmware programs; a combinational logic circuit; interconnection of the aforesaid. The electrical circuitry may be located entirely at the machine, or distributed between one or more of: the machine; external devices; a server system.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board machine or distributed as part of the system. As used herein, any machine executable instructions, or computer readable media, may be configured to cause a disclosed method to be carried out, e.g. by the machine or system as disclosed herein, and may therefore be used synonymously with the term method.

As used herein, the term “code” may refer to storage medium that encodes preparation information. The code may be an optically readable code, e.g. a bar code. The code may be formed of a plurality of units, which can be referred to as elements or markers.

As used herein, the term “preparation information” may refer to information related to a preparation process. Depending on the implementation of the processing unit said information may vary. The parameters that may be associated container processing unit that comprises a fluid processing system, can include one or more of: fluid pressure; fluid temperature; mass/volumetric flow rate; fluid volume; filtering/purification parameters for the fluid, and; carbonation parameters for the fluid. More general parameters can include one or more of: container geometric parameters, e.g. shape or volume, and; the type of precursor.

As used herein the term “wood pulp based” may refer to the material or a portion of material forming the container which is one or more of: porous; fibrous; cellulosic; formed of cellulosic material; formed of natural cellulosic material; formed of reconstituted or regenerated cellulosic material; non-woven; is composed entirely of or is a composition of wood pulp, and; is wet formed. A thickness of the wood-based material may be 0.25 mm to 0.75 mm or about 0.5 mm. The wood-based material may be 200-400 gsm.

As used herein the term “non-woven” may refer to a fabric-like material which is not woven or knitted. A non-woven material may be made from bonded together fibres. As used herein the term “porous” may refer to material configured with interstices to transmit water (or other liquid) therethrough. As used herein the term “fibrous” may refer to material comprised of fibres, which may be present in one or more of the material constituents. As used herein the term “cellulosic” or “cellulosic material” may refer to conventionally woody and/or non-woody materials, e. g. manila hemp, sisal, jute, bleached and unbleached soft wood and hard wood species. A cellulosic material may include a regenerated or reconstituted cellulose. As used herein the term “natural cellulosic material” may refer to conventionally woody materials, which are not regenerated. As used herein the term “reconstituted or regenerated cellulosic material” may refer natural cellulosic material subject to processing that comprises reconstitution or regeneration, examples include rayon and lyocell. As used herein the term “wood pulp” may refer to a lignocellulosic fibrous material, which may be prepared by mechanical or chemical separation of cellulose fibres from one or more of wood, fibre crops, paper or rags. As used herein the term “wet formed” may refer to a process of forming from an aqueous solution of fibres. The aqueous solution of fibres may be heated and pressed in a mould to set the material and remove water therefrom.

### [General System Description]

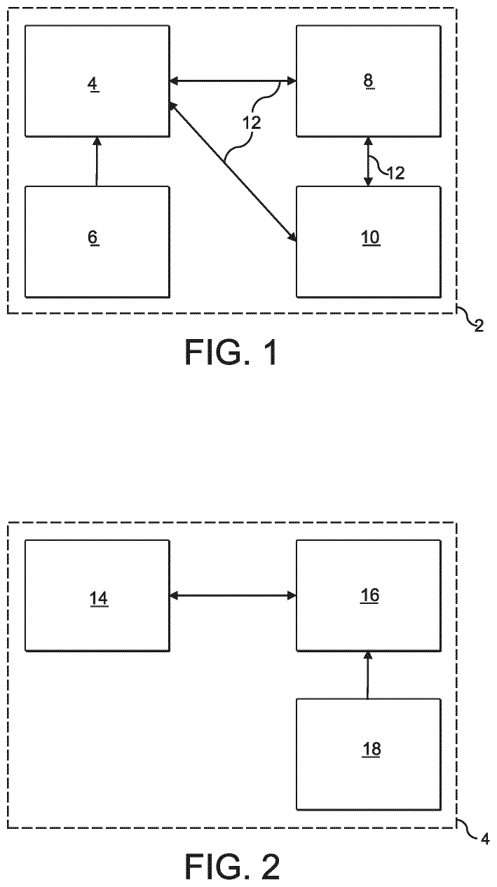

Referring to FIG. 1, the system 2 comprises a machine 4, a container 6, server system 8 and a peripheral device 10. The server system 8 is in communication with the machine 4 via a computer network 12. The peripheral device 10 is in communication with the machine 4 via the computer network 12.

In variant embodiments, which are not illustrated: the peripheral device and/or server system is omitted.

Although the computer network 12 is illustrated as the same between the machine 4, server system 8 and peripheral device 10, other configurations are possible, including: a different computer network for intercommunication between each device: the server system communicates with the machine via the peripheral device rather than directly. In a particular example: the peripheral device communicates with the machine via a communication interface, e.g. with a Bluetooth™ protocol, and; the server system communicates with the machine via a via a wireless interface, e.g. with a IEE 802.11 standard, and also via the internet.

### [Machine]

Referring to FIG. 2, the machine 4 comprises: a processing unit 14 for processing the precursor material; electrical circuitry 16, and; a code reading system 18.

The electrical circuitry 16 controls the code reading system 18 to read a code (not illustrated in FIG. 2) from the container 6 and determine preparation information therefrom. The electrical circuitry 16 uses the preparation information to control the processing unit 14 to execute a preparation process, in which the precursor material is process to a beverage or foodstuff or a precursor thereof.

In variant embodiments, which are not illustrated: the code and code reading system is omitted and the machine executes one or more preparation processes stored on an electronic memory of the electrical circuitry.

### [First Example of Processing Unit]

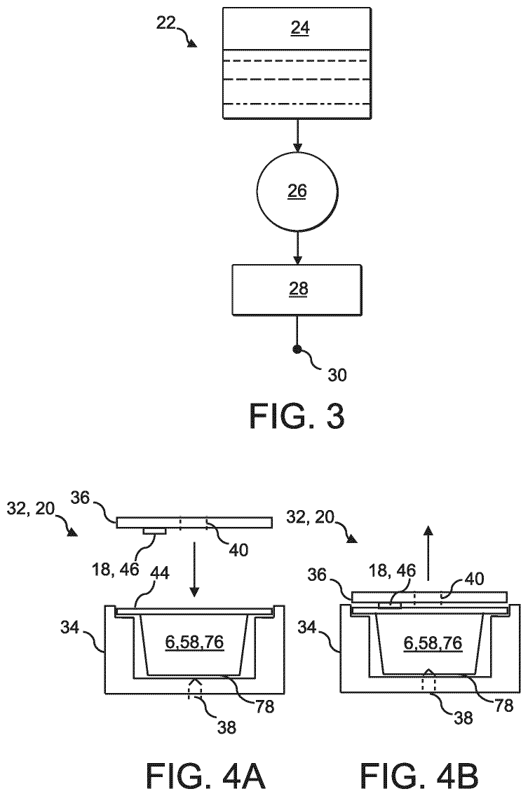

Referring to FIGS. 3 and 4, in a first example of the processing unit 14, said unit comprises a container processing unit 20 and a fluid conditioning system 22.

The container processing unit 20 is arranged to process the container 6 to derive a beverage or foodstuff from precursor material (not illustrated) therein. The fluid conditioning system 22 conditions fluid supplied to the container processing unit 20. The electrical circuitry 16 uses the preparation information read from the container 6 to control the container processing unit 20 and the fluid conditioning system 22 to execute the preparation process.

The code reading system 18 of the machine may comprise an image capturing unit 46 to detect and/or read a code element 44 positioned on the capsule for processing specific recipes and propose optimised extraction of the ingredient contained in the capsule.

### [Fluid Conditioning System]

Referring to FIG. 3, the fluid conditioning system 22 includes a reservoir 24; pump 26; heat exchanger 28, and; an outlet 30 for the conditioned fluid. The reservoir 24 contains fluid, typically sufficient for multiple preparation processes. The pump 26 displaces fluid from the reservoir 24, through the heat exchanger 28 and to the outlet 30 (which is connected to the container processing unit 20). The pump 26 can be implement as any suitable device to drive fluid, including: a reciprocating; a rotary pump; other suitable arrangement. The heat exchanger 28 is implemented to heat the fluid, and can include: an in-line, thermo block type heater; a heating element to heat the fluid directly in the reservoir; other suitable arrangement.

In variant embodiments, which are not illustrated: the pump is omitted, e.g. the fluid is fed by gravity to the container processing unit or is pressurised by a mains water supply; the reservoir is omitted, e.g. water is supplied by a mains water supply; the heat exchanger is arranged to cool the fluid, e.g. it may include a refrigeration-type cycle heat pump); the heat exchanger is omitted, e.g. a mains water supply supplies the water at the desired temperature; the fluid conditioning system includes a filtering/purification system, e.g. a UV light system, a degree of which that is applied to the fluid is controllable; a carbonation system that controls a degree to which the fluid is carbonated.

### [Container Processing Unit]

The container processing unit 20 can be implemented with a range of configurations, as illustrated in examples 1-4 below:

Referring to FIGS. 4A and 4B, a first example of the container processing unit 20 is for processing of a container arranged as a capsule 6 (a suitable example of a capsule is provided in FIG. 6, which will be discussed) to prepare a beverage. The container processing unit 20 is configured as an extraction unit 32 to extract the beverage from the capsule 6. The extraction unit 32 includes a container/capsule holding portion 34 and a closing member 36. The extraction unit 32 is movable to a capsule receiving position (FIG. 4A), in which the capsule holding portion 34 and the closing member 36 are arranged to receive a capsule 6. The extraction unit 32 is movable to a capsule extraction position (FIG. 4B), in which the capsule holding portion 34 and a closing member 36 form a seal around a capsule 6. As shown in FIG. 4A, the image capturing unit 46 provided on the closing member is arranged to read a code element 44 positioned on the capsule when the capsule is in the extraction position (FIG. 4B).

The beverage can then be extracted from the capsule 6. The extraction unit 32 can be actuator driven or manually movable between said positions.

The outlet 30 of the fluid conditioning system 22 is arranged as an injection head and/or penetrator 38 to penetrate the container to form inlets for injection of the conditioned fluid into the capsule 6 in the capsule extraction position, typically under high pressure. A beverage outlet 40 is arranged to capture the extracted beverage and convey it from the extraction unit 32.

The extraction unit 32 is arranged to prepare a beverage by the application of pressurised (e.g. at 10-20 Bar), heated (e.g. at 50-98 degrees C.) fluid to the precursor material within the capsule 6. The pressure is increased over a predetermined amount of time until a pressure of a rupturing portion, which is the closing member of the capsule 6 is exceeded, which causes rupture of said member and the beverage to be dispensed to the beverage outlet 40.

In variant embodiments, which are not illustrated, although the injection head and beverage outlet are illustrated as arranged respectively on the holding portion and closing member, they may be alternatively arranged, including: the injection head and beverage outlet are arranged respectively on the closing member and holding portion; or both on the same portion. Moreover, the extraction unit may include both parts arranged as a capsule holding portion, e.g. for capsules that are symmetrical about the flange, including a Nespresso@ Professional capsule.

Examples of suitable extraction units are provided in EP 1472156 A1 and in EP 1784344 A1, which are incorporated herein by reference, and provide a hydraulically sealed extraction unit.

In a second example (which is not illustrated) of the container processing unit a similar extraction unit to the first example is provided, however the extraction unit operates at a lower pressure and by centrifugation. An example of a suitable capsule is a Nespresso@ Vertuo capsule. A suitable example is provided in EP 2594171 A1, which is incorporated herein by reference.

In a third example, (which is not illustrated) the capsule processing unit operates by dissolution of a beverage precursor that is selected to dissolve under high pressure and temperature fluid. The arrangement is similar to the extraction unit of the first and second example, however the pressure is lower and therefore a sealed extraction unit is not required. In particular, fluid can be injected into a lid of the capsule and a rupturing portion is located in a base of a storage portion of the capsule. An example of a suitable capsule is a Nespresso@ Dolce Gusto capsule. Examples of suitable extraction units are disclosed in EP 1472156 A1 and in EP 1784344 A1, which are incorporated herein by reference.

In a fourth example, (which is not illustrated) the container processing unit is arranged as a mixing unit to prepare a beverage or foodstuff precursor that is stored in a container that is a receptacle, which is for end user consumption therefrom. The mixing unit comprises an agitator (e.g. planetary mixer or a spiral mixer or a vertical cut mixer) to mix and a heat exchanger to heat/cool the beverage or foodstuff precursor in the receptacle. A fluid supply system may also supply fluid to the receptacle. An example of such an arrangement is provided in WO 2014067987 A1, which is incorporated herein by reference.

### [Control Electrical Circuitry]

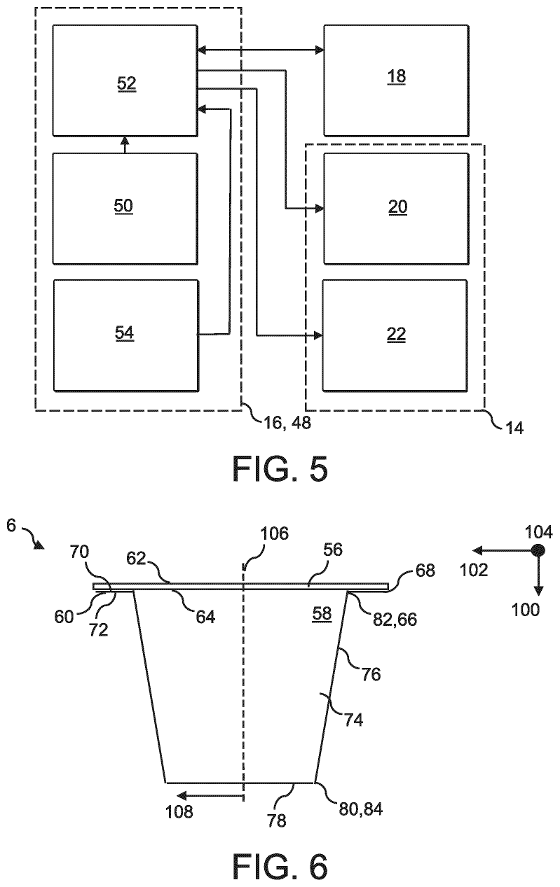

Referring to FIG. 5, the electrical circuitry 16 is implemented as control electrical circuitry 48 to control the processing unit 14 to execute a preparation process. In the embodiment of FIG. 5, for illustrative purposes, the processing unit 14 is exemplified as the first example, which comprises a container processing unit 20 and a fluid supply unit 22.

The electrical circuitry 16, 48 at least partially implements (e.g. in combination with hardware) an: input unit 50 to receive an input from a user confirming that the machine 4 is to execute a preparation process; a processor 52 to receive the input from the input unit 46 and to provide a control output to the processing unit 14, and; a feedback system 54 to provide feedback from the processing unit 14 during the preparation process, which may be used to control the preparation process.

The input unit 50 is implemented as a user interface, which can include one or more of: buttons, e.g. a joystick button or press button; joystick; LEDs; graphic or character LCDs; graphical screen with touch sensing and/or screen edge buttons; other like device; a sensor to determine whether a container has been supplied to the machine by a user.

The feedback system 54 can implement one or more of the following or other feedback control-based operations:
a flow sensor to determine a flow rate/volume of the fluid to the outlet 30 (shown in FIG. 3) of the fluid supply system 22, which may be used to meter the correct amount of fluid to the container 6 and thus regulate the power to the pump 26;
a temperature sensor to determine a temperature of the fluid to the outlet 30 of the fluid supply unit 22, which may be used to ensure the temperature of fluid to the container 6 is correct and thus regulate the power to the heat exchanger 28);
a level sensor to determine a level of fluid in the reservoir 24 as being sufficient for a preparation process;
a position sensor to determine a position of the extraction unit 32 (e.g. a capsule extraction position or a capsule receiving position).

It will be understood that the electrical circuitry 16, 48 is suitably adapted for the other examples of the processing unit 14, e.g.: for the second example of the container processing system the feedback system may be used to control speed of rotation of the capsule.

### [Container]

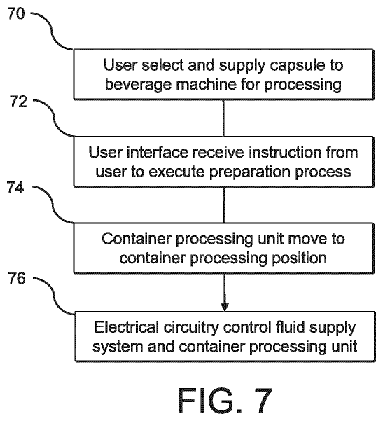

Referring to FIG. 7, a container 6, that is for use with the first example of the processing unit 14 comprises the container 6 arranged as a capsule 6. The capsule 6 includes: a closing member 56; a storage portion 58, and; a flange portion 60.

A local container coordinate axis includes a depth direction 100, longitudinal direction 102, and a lateral direction 104. A rotational axis 106 extends in the depth direction 100 and defines a radial direction 108, which is in a plane defined by the longitudinal direction 102, and the lateral direction 104.

The capsule 6 has a circular cross-section when viewed in the plane defined by the longitudinal direction 102, and the lateral direction 104.

The closing member 56 is arranged in the plane defined by the longitudinal direction 102, and the lateral direction 104. The closing member 56 closes the storage portion 58 and comprises a flexible membrane. The closing member 56 has an exterior surface 62 that faces away from the storage portion 58 and an interior surface 64 that faces towards the storage portion 58.

The flange portion 60 is arranged to interconnect the storage portion 58 and closing member 56 to hermetically seal the precursor material. The flange portion 60 is arranged as an annular ring, which extends in the radial direction 108 from an interior edge 66 to an exterior edge 68. The flange portion 60 presents an upper surface 70, which is arranged in the plane defined by the longitudinal direction 102, and the lateral direction 104. The upper surface 70 is connected by an adhesive to a periphery of the interior surface 64 of the closing member 56. A lower surface 72 of the flange faces towards the storage portion 58.

The storage portion 58 includes a cavity 74 for storage of the precursor material (not illustrated). The cavity 74 includes a sidewall 76 and a base 78. The sidewall 76 extends principally in the depth direction 100 from a proximal edge 80 to a distal edge 82, wherein proximal and distal are defined relative the base 78. The sidewall 76 tapers with an increasing radial dimension from the proximal edge 80 to the distal edge 82. The base 78 extends principally in the radial direction 108, but also has a lesser component in the depth direction 100. The base 78 extends from the axis 106 to a peripheral edge 84 that adjoins the proximal edge 80 of the sidewall 76. The distal edge 82 of the sidewall 76 adjoins the interior edge 66 of the flange portion 60. The storage portion 58 and flange portion 60 are integrally formed.

The capsule 6 has a diameter of 2-5 cm and an axial length of 2-4 cm. Constructional, manufacturing and/or (beverage) extraction details of containers and/or closing members are for instance disclosed in EP 2155021, EP 2316310, EP 2152608, EP2378932, EP2470053, EP2509473, EP2667757 and EP 2528485.

In variant embodiments, which are not illustrated: the capsule may have other cross-section shapes, including square, other polygons, or elliptical; the closing member may be rigid or other non-membrane formation; the flange is alternatively connected to the upper surface of the closing member, e.g. by crimping; the sidewall is alternatively arranged, including with the reverse taper or is aligned to the depth direction, or is curved; the base is alternatively arranged, including with as flat or curved; the flange portion is connected to the storage portion rather than being integrally formed; the closing member is arranged as a storage portion, e.g. it comprises a cavity, and; the flange portion is omitted, e.g. the closing member connects directly to the storage portion.

Referring to FIGS. 4A and 4B, the base 78 of the storage portion 58 is perforated by a penetrator 38 to form inlets for injection of conditioned fluid into the cavity 74 as will be discussed. The penetrator 38 may be arranged as separate blades or a blade that integrates the injector.

### Preparation Process

Referring to FIG. 7, the execution of a process for preparing a beverage/foodstuff from precursor material is illustrated:
Block 70: a user supplies a container 6 to the machine 4.
Block 72: the electrical circuitry 16 (e.g. the input unit 50 thereof) receives a user instruction to prepare a beverage/foodstuff from precursor, and the electrical circuitry 16 (e.g. the processor 52) initiates the process.
Block 74: the electrical circuitry 16 controls the processing unit 14 to process the container (e.g. in the first example of the container processing unit 20, the extraction unit 32 is moved from the capsule receiving position (FIG. 4A) to the capsule extraction position (FIG. 4B)).
Block 76: the electrical circuitry 16, based on preparation information either read from a code on the container or stored on a memory, executes the preparation process by controlling the processing unit 14. In the first example of the processing unit this comprises: controlling the fluid conditioning system 22 to supply fluid at a temperature, pressure, and time duration specified in the preparation information to the container processing unit 20.

The electrical circuitry 16 subsequently controls the container processing unit 20 to move from the capsule extraction portion though the capsule ejection position to eject the container 6 and back to the capsule receiving position.

In variant embodiments, which are not illustrated: the above blocks can be executed in a different order, e.g. block 72 before block 70; some block can be omitted, e.g. where a machine stores a magazine of capsules block 70 can be omitted.

As part of the preparation process, the electrical circuitry 16 can obtain additional preparation information via the computer network 12 from the server system 8 and/or peripheral device 10 using a communication interface (not illustrated) of the machine.

### [Container Stiffener Portions]

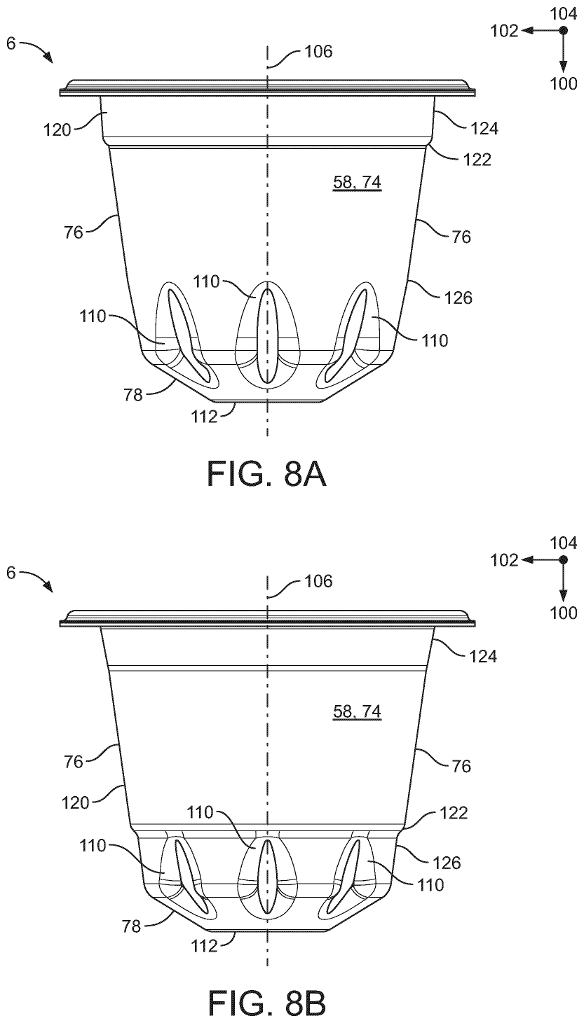

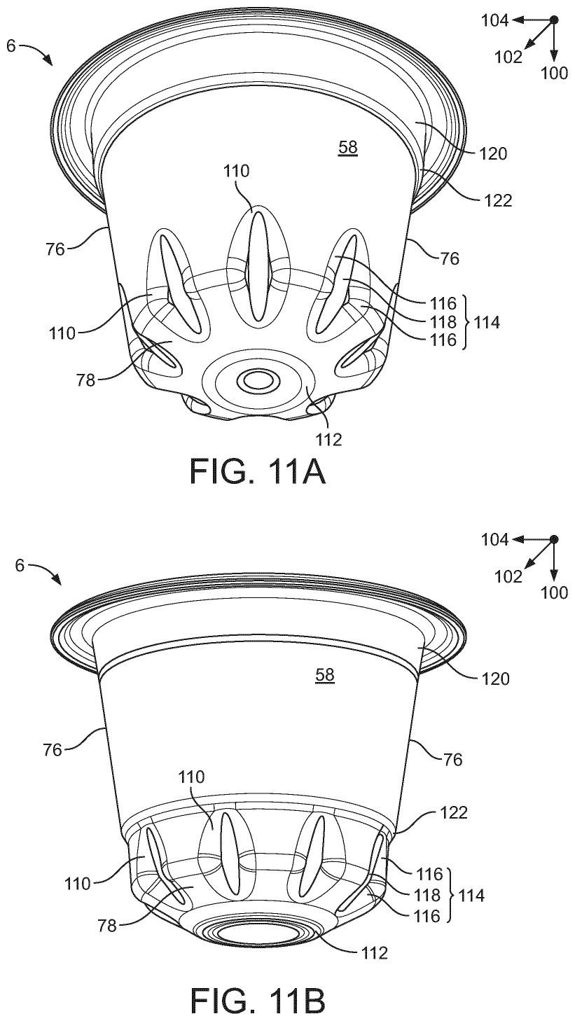

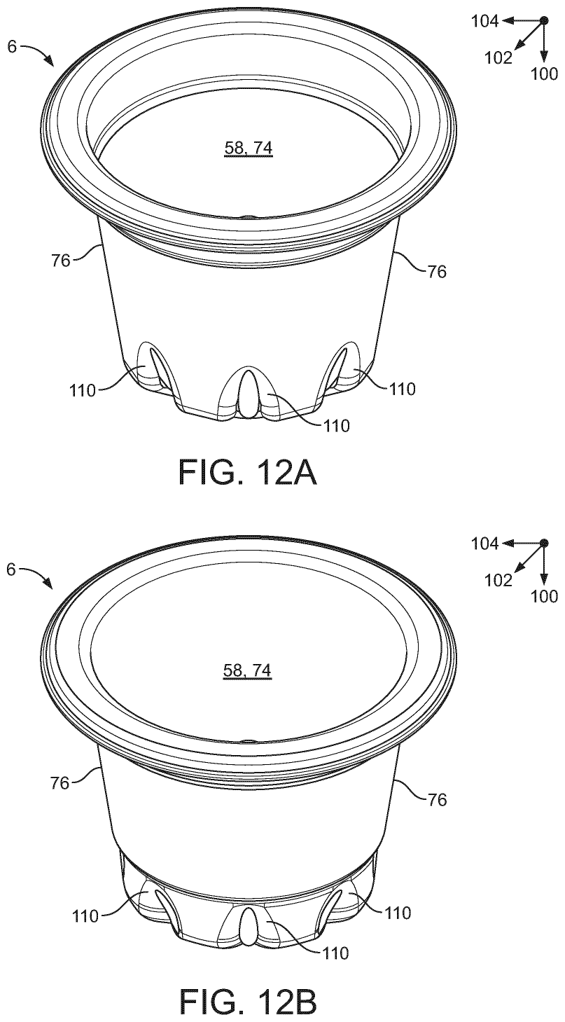

Referring to FIGS. 8A to 13B, the containers 6 associated with two possible containers embodiments of FIG. 6 are described as a single container for the common references. Hence the container 6 includes the storage portion 58 formed of a wood pulp-based material. In variant embodiments, which are not illustrated, only part of the storage portion may be formed of the wood pulp-based material, e.g. only the base or a base region as defined herein.

The storage portion 58 includes stiffener portions 110, which are disposed to stiffen the storage portion 58. In particular, the stiffener portions 110 stiffen proximal a perforation region 112 of the storage portion 58 that is penetrated by the penetrator 38 (show in FIGS. 4A and 4B) so that the perforation region 112 may be more easily penetrated.

The perforation region 112 once penetrated provides one or more fluid inlets (not illustrated) for injection of conditioned fluid into the cavity 74 of the storage portion 58 for processing the precursor material. Conditioned fluid is injected into the container holding portion 34 (show in FIGS. 4A and 4B), which is fluidically connected to said fluid inlets. The perforation region 112 is arranged on the base 78 of the storage portion 58 as an annular ring, which is centred about the axis of rotation 106.

The penetrator (not show) comprises three perforation elements, which are circumferentially disposed at equal angular pitches about around the annular ring of the perforation region 112. Each of the perforation elements is arranged to form a dedicated inlet. A perforation element has a cross-sectional area of 2-5 mm². The penetrator applies a combined force (i.e. through all of the perforation elements summed together) of 1-50 N or 2-10 N in the counter depth direction 100 into the perforation region 112. The perforation region 112 can be perforated by various failure modes including incision and/or brittle fracture, as will be discussed.

The stiffener portions 110 prevent the perforation region 112 of the base 78 displacing by more than 0.5-2 mm in the counter depth direction 100, when the perforation region 112 is subject to a compressive force in said counter depth direction 100 of 1-50 N or 2-10 N, which is applied by the penetrator.

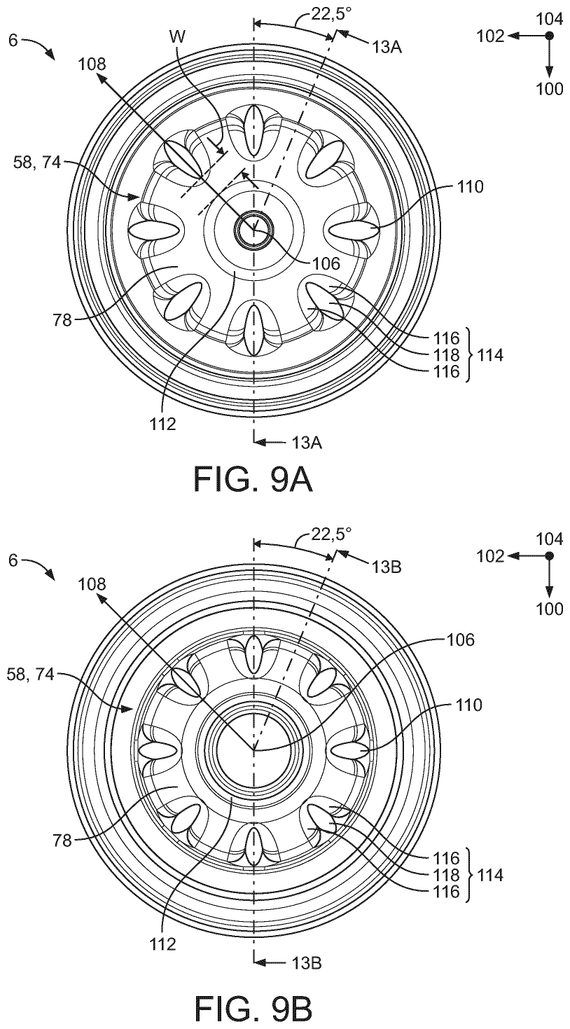

As can be seen in FIGS. 9A and 9B, the size and dimension of the perforation region 112 may vary depending on the size and/or design of the container and/or of the perforation element of the beverage machine's penetrator to ensure full and efficient perforation.

In variant embodiments, which are not illustrated: the penetrator comprises other numbers of perforation elements, e.g. 1, 2 or 4; the perforation elements have a different cross-sectional area, e.g. the same total cross-sectional area as in the example may be distributed across the number of perforation elements; the penetrator applies a different force; the perforation region is arranged with a shape other than an annular ring, including as a circle or square.

The stiffener portions 110 are arranged as eight discrete units, which are circumferentially spaced apart from each other about the axis 106 with an equal angular pitch. The stiffener portions 110 extend continuously over both the base 78 and a proximal portion of the side wall 76.

As can be best seen in FIGS. 9A to 11B and 13A to 13B, the stiffener portions 110 are arranged as channels 114 that have a sidewalls 116 and a base 118. The base 118 is linear and radially aligned. The sidewalls 116 curve into the base 118, hence the channels 114 are generally V-shaped with curved peripheries.

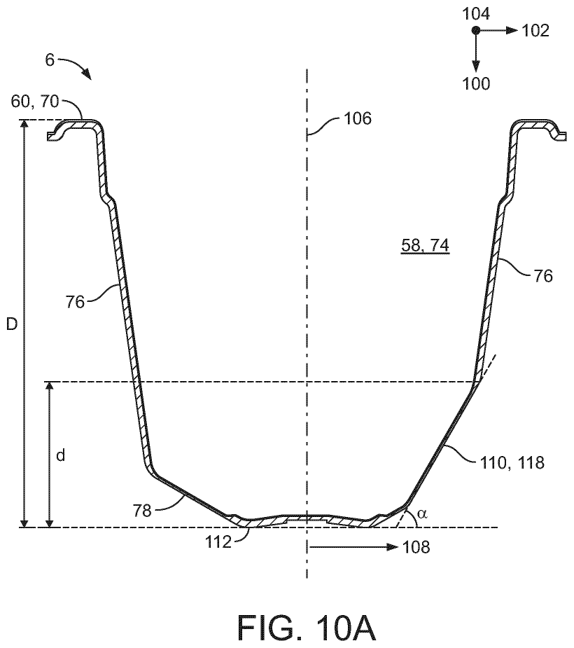

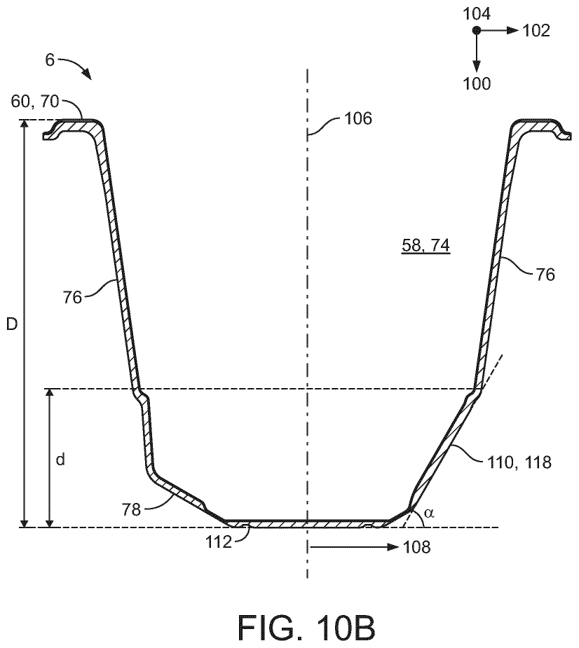

The channels 114 extend principally in the depth direction 100 and with a radial direction 108 component so that the base 118 is angled at an angle α of about 50-60 degrees to a plane defined by the longitudinal direction 102 and the lateral direction 104 (as best seen in the cross-section of FIG. 10A or 10B, when observing the right stiffener portion side).

As can be best seen in FIGS. 10A and 10B, the proximal end of the sidewall 76 has a depth dimension d, which is measured from a lowest position of the base 78 to a distal end of a base 118 of the stiffener portion 110, that is less than about 40% of the total depth D, which is measured from said lowest position of the base 78 to the upper surface 70 of the flange portion 60.

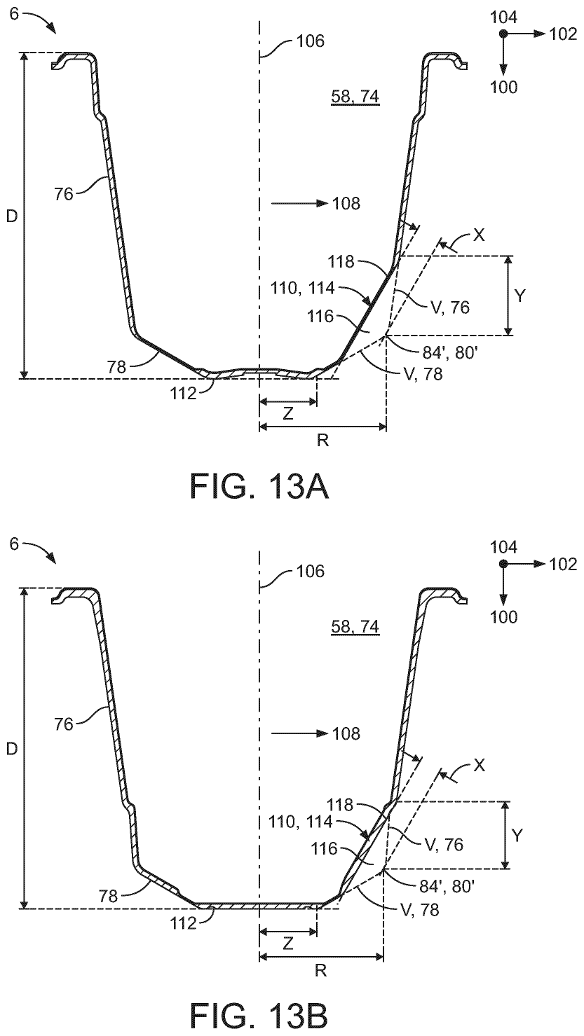

As can be best seen in FIGS. 10A, 10B, 13A and 13B, the stiffener portions 110 protrude in the counter radial direction 108 in to an interior of the cavity 74, and no portion of the stiffener portion 110 has a greater radial dimension than a corresponding portion of the sidewall 76 that does not comprise a stiffener portion 110 (as best seen in the cross-section of FIG. 13A or 13B, when comparing the stiffener portion 110 to the virtual section line V of an equivalent section without a stiffener portion). In this way the container 6 can be used with a container holding portion 34 that is not specifically adapted to hold the container 6 (e.g. by implementing grooves to contain an outwardly extending portion of a stiffener portion).

In variant embodiments, which are not illustrated: there are other numbers of stiffener portions, including 3, 4 or 6; the stiffener portions may directly adjoin each other; the stiffener portions have other profiles including U or V-shaped; the stiffener portions extend outwardly in the radial direction; the stiffener portions may be alternatively arrange, including with a curved or stepped base and a base which is not radially aligned; the base may be alternatively angled including an angle α of about 30-70 degrees, and; d, is alternatively dimensioned to be is less than about 50% or 30% of D and/or d may have a minimum of at least 10 or 20% D.

Referring to FIGS. 13A and 13B, the stiffener portions 110 extend along the base 78 from a virtual peripheral edge 84′ of the base 78 (which is present for a section that does not comprise a stiffener portion as indicated by the virtual line V) to proximal the perforation region 112. As best seen in FIG. 9A, a distance W defined by a distal end of the base 118 of the channel 114 is within 4 mm in the radial direction 108 of the proximal most edge of the perforation region 112. The distance W may vary depending on the size and dimension of the perforation region 112.

As best seen in FIGS. 13A and 13B, the stiffener portions 110 have a maximum channel depth X of about 3 mm. The channel depth X is measured from perpendicular the base 118 to an intersection of the virtual section line V that does not comprise a stiffener portion. In the example the intersection between the perpendicular distance and virtual section line V occurs at the virtual proximal edge 80′ of the sidewall 76. In variant embodiments, which are not illustrated: the depth X can be alternatively dimensioned, inducing 5 mm -2 mm or 10 mm -2 mm; the greatest depth may be at an position other than the proximal edge.

As best seen in FIGS. 13A and 13B, the stiffener portions 110 extend along the sidewall 76 in the counter depth direction 100 by a distance Y, which is determined as from a virtual proximal edge 80′ of the sidewall 76 for the virtual section line V to a distal end of the channel 114. Distance Y is less than 40% or 30% of the total depth D. A minimum distance of Y may be greater than 10% or 20% of the total depth D.

The stiffener portions 110 extend along the base 78 in the counter radial direction 108 from the virtual peripheral edge 84′ of the base 78 for the virtual section line V to a radii Z. Radii Z is greater than 30% or 40% of the total radii R of the base. A maximum radii for Z may 90 or 80% of radii R.

As best seen in the cross-section of FIG. 13A or 13B, when comparing the right stiffener portion 110 side to virtual line V, the stiffener portions 110 bridge the base 78 and a proximal region of the sidewall 76 that would otherwise not be bridged.

In variant embodiments, which are not illustrated: the stiffener portions are alternatively formed including as portions of increased material thickness e.g. a rib as opposed to a channel that extends into the interior of the cavity, and; the channel may include regions of increased material thickness including at the base.

At block 74, as shown in FIG. 7, the previously described preparation process can be implemented by: arranging the container 6 in the container holding portion 34 of the processing unit 14 of a machine 2. The container 6 can be penetrated by the penetrator 38 to form inlets whilst stiffening the container 6 to resist displacement with the stiffener portions 110.

A method of forming the storage portion can include wet forming the storage portion and stiffener portions concurrently, e.g. via the same mould/press. Alternatively, the stiffener elements may be subsequently pressed into the storage portion.

### [Container Shoulder]

Referring to FIGS. 8A, 8B, 11A, 11B, 14A and 14B, the sidewalls 76 comprise a shoulder 120, which is arranged to adjoin the flange portion 60. The shoulder 120 extends in the depth direction 100 from the lower surface 72 of the flange portion 60 to a rim 122. The shoulder 120 defines a linear outer surface 124 between the flange portion 60 and rim 122. The outer surface 124 tapers with decreasing radial extent from the flange portion 60 to the rim 122. Said tapering may facilitate more convenient location of the container 6 in the container holding portion 34. The rim 122 is curved.

The rim 122 location on the container 6 may vary as visible when comparing FIG. 8A and FIG. 8B. The rim 122 of the container 6 of FIG. 8A is positioned in the proximity of the flange portion 60, whereas the rim 122 of the container 6 of FIG. 8B is located in the proximity of the base portion 78 of the container.

In variant embodiment, which are not illustrated: the shoulder is separated from the flange portion by a gap; the outer surface is alternatively profiled, including as curved or is aligned in the depth direction, and; the rim is alternatively profiled, including as a step or linear ramp.

The outer surface 124 has a greater radial extent than a void defining region 126 of the sidewalls 76. The void defining region 126 of the sidewalls 76 extends for the remainder of the sidewalls 76 from the shoulder 120 to the base 78.

In variant embodiment, which are not illustrated: a lower portion of the sidewalls includes a second shoulder that engages with the container holding portion, such that the void defining region of the sidewalls does not extend for the remainder of the sidewalls.

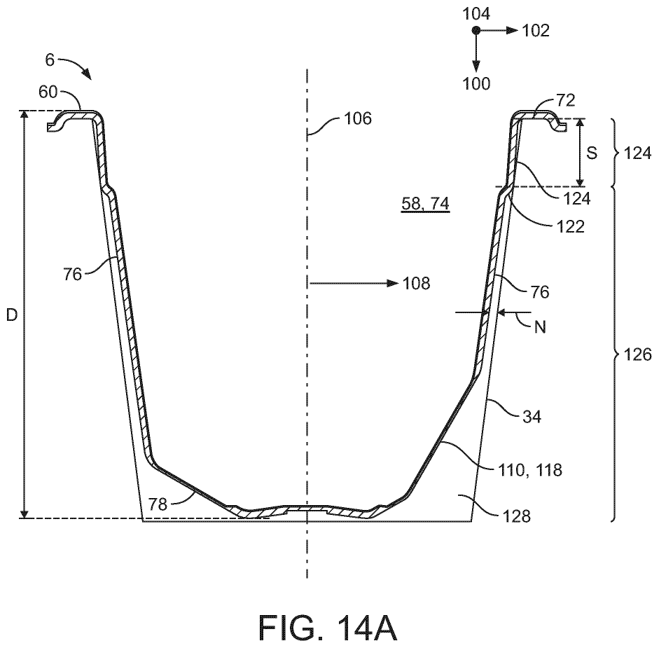

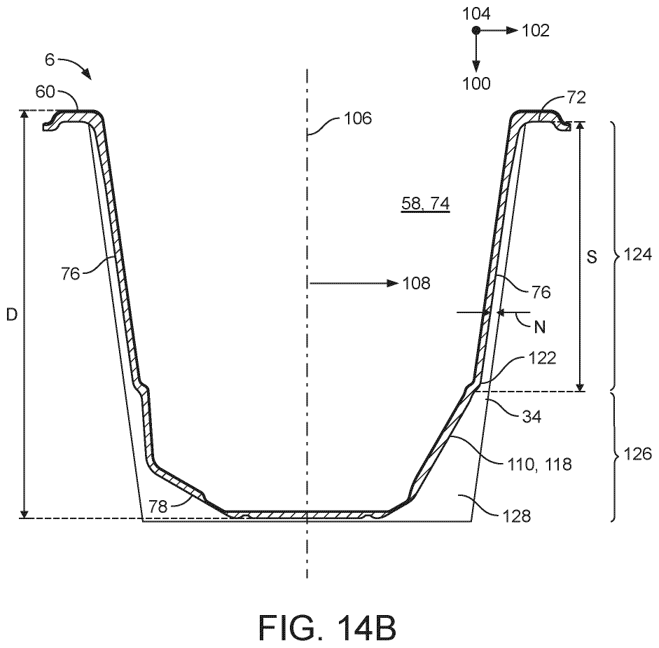

Referring to FIGS. 14A and 14B, the shoulder 120 is arranged to engage an upper region of the container holding portion 34 of the processing unit 14 of the machine 2 with the void defining region 126 positioned separated in the radial direction 108 from the container holding portion 34 to define a void 128 therebetween.

The shoulder 120 is arranged to correspond in shape to the upper region of the container holding portion 34 such that the entire outer surface 124 is engaged for improved accuracy in positioning.

In variant embodiment, which are not illustrated: the outer surface includes grooves or other surface discontinuities that do not engage the container holding portion for reduced sticking.

The shoulder 120 has a depth distance S between the lower surface 72 of the flange portion 60 and an intersection of the rim 122 and the outer surface 124 that is of less than about 15% of the total depth D of the storage portion 58 (as defined previously).

In variant embodiment, which are not illustrated: S is alternatively dimensioned including less than 40% or 30% of D, and; a minimum distance for S can be greater than 5% or 10% of D.

The void region 128 has an separation distance N in the radial direction 108, between the void defining region 126 of the sidewall 76 and a directly adjacent portion of the container holding portion 34, of 1 mm -2 mm. An average of the separation distance N along the depth of the void defining region 126 of the sidewall 76 (excluding a stiffener portion 110) is about 1.5 mm.

In variant embodiment, which are not illustrated: N is alternatively dimensioned including greater than 0.5 mm and/or less than 5 mm; the average separation distance is greater than 0.5 mm or 1 mm or 2 mm.

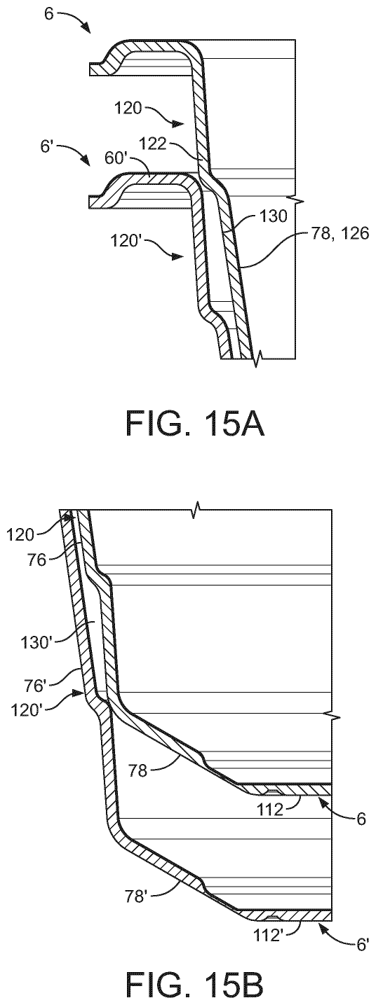

Referring to FIG. 15A, the container 6 is arranged to be stacked partially within a second corresponding in shape container 6′. The rim 122 of the shoulder 120 of the container 6 engages the flange portion 60′ (including a proximal portion of the storage portion) of the second container 6′. A part of the void defining region 126 of the sidewall 76 of the container 6 that is adjacent the shoulder 120′ of the second container 6′ is distal said shoulder 120′ to define a void 130. The remainder of the void defining region 126 of the sidewall 76 of the container 6 may also define the void 130. With such an arrangement, containers prior to filling may be stacked with reduced sticking.

Referring to FIG. 15B, the container 6 is arranged to be stacked partially within a second corresponding in shape container 6′. The distal edge 80 (being the intersection of the sidewall 76 and the base 78) of the container 6 engages the rim 122′ of the shoulder 120′ of the container 6′. A part of the void defining region 126 of the sidewall 76 of the container 6 that is adjacent the shoulder 120′ of the second container 6′ is distal said shoulder 120′ to define a void 130′. With such an arrangement, containers prior to filling may be stacked with reduced sticking.

At block 74, as shown in FIG. 7, the previously described preparation process can be implemented by: arranging the container 6 in the container holding portion 34 of the processing unit 14 of a machine 2, and; engaging the shoulder 120 of the sidewall 76 of the container 6 with the container holding portion 34 to position the void defining region 126 of the sidewall 76 away from the container holding portion 34 to define the void region 128.

The container 6 can be penetrated by the penetrator 38 to form inlets and conditioned fluid injected into said inlets whilst the void region 128 is maintained. The container 6 can be ejected from the container holding portion 34 whilst the void region 128 is maintained.

A method of filling the container 6 with precursor material (not shown) comprises: arranging the storage portion 58 of the container 6 in a container holding portion (not shown, although it can be envisaged as being similar to the container holding portion 34 of the machine 2) of a filling machine (also not shown). This step can therefore be implemented as discussed for the container holding portion 34. The storage portion 58 may be supplied to the filling machine with two or more containers stacked in the previously described arrangement. After filling the storage portion 58 can be closed with the closing member 56.

A method of forming the storage portion can include wet forming the storage portion and shoulder concurrently, e.g. via the same mould/press. Alternatively, the shoulder may be subsequently pressed into the storage portion.

### [Container Perforation Region]

Referring to FIGS. 8A to 11B and 16, the perforation region 112 as discussed previously is treated to facilitate comparatively easier perforation by the penetrator 38 (as shown in FIGS. 4A and 4B) than a portion that is not treated, as will be discussed.

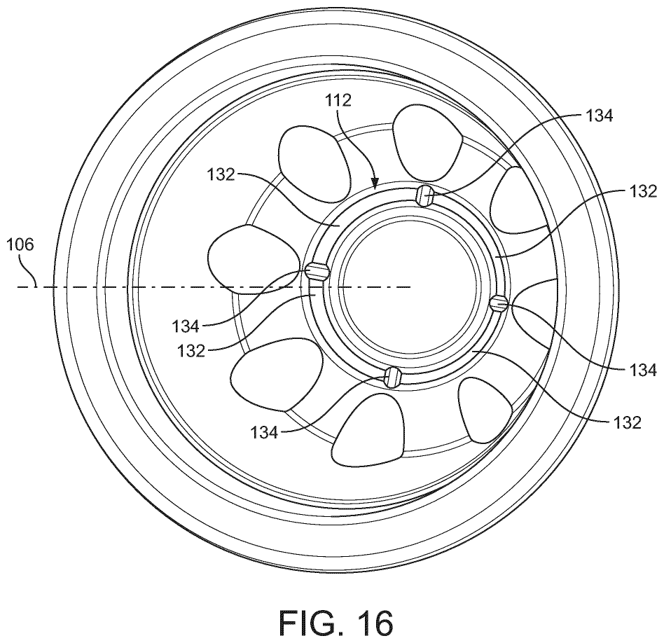

Referring to FIG. 16 the annular ring of the perforation region 112 is arranged as three segments 132, which are radially bounded by three bridges 134. The segments 130 are treated and the bridges 134 are not treated.

For the previously discussed example of the penetrator 38, there are three penetration elements, which are arranged with an equal angular pitch of 120 degrees to each other about the axis 106. The bridges 134 have a different equal angular pitch: since there are four bridges 134 the angular pitch is 90 degrees about the axis 106. In this way if the rotational orientation of the container 6 about the axis 106 is unknown, it can be ensured that even if one penetration element happens to be aligned to a bridge 134, others will not, hence it may be ensured that at least one penetration element entirely penetrates the perforation region 112, 132 rather than a bridge 134.

In variant embodiment, which are not illustrated: the penetrator has a number other than three penetration elements, e.g. 2 or 4; perforation region is composed of a number other than four segments, e.g. 3 or 5; it is preferable that the number of segments is different to the number of penetration elements, and; the bridges are omitted so that the penetration region is a continuous ring.

The penetration region 112 is treated via elevated temperature and an pressure via pressing to glassify the wood pulp based material. The temperature is 100-300 degrees C. The pressure is 1×10⁵-1×10⁷ Pa. It will be understood that any suitable temperature and pressure combination may be selected, e.g. the glassification may be achieved via cold pressing, which can include pressing at room temperature but to a higher pressure than for hot pressing. The elevated temperature and pressing force can be applied for 5-60 seconds.

The treated perforation region 112 has a reduced thickness. For example, a 0.5 mm thick material may have the thickness reduced to 0.3 mm thickness. The treatment may be applied until said thickness reduction has been achieved.

As mentioned, the size and dimension of the treated perforation region 112 may vary according to the needs to optimize the interaction between the container 6 and the beverage preparation machine. This is visible on FIGS. 9A and 9B where the perforation region 112 of FIG. 9B is bigger (here with a larger diameter) than the one of FIG. 9A.

As used herein the term “glassification” or “glassify” may refer to a change in one or more material properties of the wood pulp material to be more glass like. It may be characterised by one or more of the following material properties (compared to an untreated wood pulp material): a glass transaction temperature above ambient temperature; a harder material; a more brittle material; a material with low energy absorption before fracture; a thinner sectioned material; a material with reduced fibre interstices; reduced water absorption; increased stiffness, and; transitioning the material to a glassy state.

In variant embodiments, alternative treatments are implemented including: applying a coating, and; scoring to reduce material cross-section. As used herein the term “applying a coating” may refer to the application of a coating to the wood pulp based material to close pores/interstices between the fibres and/or to act as a barrier. This may provide reduced water absorption, which may be advantageous for the reasons previously given. This may also provide a more brittle type failure, which may be advantageous for the reasons previously given. The coating may comprise caramelised sugar or starch or other suitable coating. As used herein the term “scoring” may refer to the removal of a portion of material by a cutting tool or otherwise. The portion of material that is removed may be up to 50% of the material thickness. The portion of material may be one or more of: a line; a perimeter of the perforation region; the area of the perforation region.

By treating the perforation region 112 of the wood pulp-based container 6 with the disclose treatment method, it may be easier to penetrate by the penetrator 38 than for a region that is not treated. This may be characterised by one or more of the following ways: a perforation of the perforation region that comprises a more brittle type failure mode with comparatively lower energy absorption rather than a ductile type failure mode with comparatively higher energy absorption of an untreated region; less displacement of the penetrator to achieve full penetration (e.g. due to a reduced thickness of the perforation region and/or less movement of the perforation region with the penetrator) and; a penetration with a lower maximum force.

For a perforation region 112 that is treated to be 0.3 mm thick from 0.5 mm, for penetration elements with a total penetration area of 6-15 mm², perforation may occur for 1-50 N or 2-10 N.

The presented values of the perforation region 112 on the container 6 may be defined differently and may vary depending on the beverage preparation machine's characteristics.

At block 74, as shown in FIG. 7, the previously described preparation process can be implemented by: arranging the container 6 in the container holding portion 34 of the processing unit 14 of the machine 2. The perforation region 112 of the container 6 can be penetrated by the penetrator 38 to form inlets.

A method of forming the storage portion can include wet forming the storage portion. Subsequently the perforation region 112 may be treated by one of the previously described processes. The bridges 134 may be formed by a press shaped to treat only the segments 132.

In variant embodiments, which are not illustrated: other parts of the container 6 may be treated by the processes disclosed herein in addition to or instead of the perforation region 112. For example, the flange portion 60 may be treated to provide an improved surface to carry a code on the lower surface 72 of the flange portion 60. In particular, a heat and pressing process may be applied to reduce a thickness of a flange portion 60 when formed of a wood pulp based material so that the flange portion 60 has a comparable thickness to that a container formed of conventional materials (e.g. aluminium) to ensure compatibility with existing machines. The heat and pressing process may also provide a more consistent surface to act as a substrate for the code, which may improve code reading reliability. In such an example the preparation process can include a step of reading the code to extract preparation information therefrom. The step of reading the code can include rotating the code relative a code reader.

It will be appreciated that any of the disclosed methods (or corresponding apparatuses, programs, data carriers, etc.) may be carried out by either a host or client, depending on the specific implementation (i.e. the disclosed methods/apparatuses are a form of communication(s), and as such, may be carried out from either ‘point of view’, i.e. in corresponding to each other fashion). Furthermore, it will be understood that the terms “receiving” and “transmitting” encompass “inputting” and “outputting” and are not limited to an RF context of transmitting and receiving radio waves. Therefore, for example, a chip or other device or component for realizing embodiments could generate data for output to another chip, device or component, or have as an input data from another chip, device or component, and such an output or input could be referred to as “transmit” and “receive” including gerund forms, that is, “transmitting” and “receiving”, as well as such “transmitting” and “receiving” within an RF context.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

As used herein, any machine executable instructions, or compute readable media, may carry out a disclosed method, and may therefore be used synonymously with the term method, or each other.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
   4 Machine
      14 Processing unit
         20 Container processing unit
         32 Extraction unit
         34 Container holding portion
         36 Closing member
         38 Injection head/penetrator
         40 Beverage outlet
         22 Fluid conditioning system
         24 Reservoir
         26 Pump
         28 Heat exchanger
         30 Outlet
      16 Electrical circuitry
         48 Control electrical circuitry
         50 Input unit
         52 Processor
         54 Feedback system
      18 Code reading system
         46 Image capturing unit
   6 Container
      56 Closing member
         62 Interior surface
         64 Exterior surface
      58 Storage portion
         74 Cavity
         76 Sidewall
         80 Proximal edge
         82 Distal edge
         120 Shoulder
         122 Rim
         124 Outer surface
         126 Void defining region
         78 Base
         84 Peripheral edge
         112 Perforation region
         132 Segments
         134 Bridges
         110 Stiffener portions
         114 Channel
         116 Sidewall
         118 Base
      60 Flange portion
         66 Interior edge
         68 Exterior edge
         70 Upper surface
         72 Lower surface

1. A container for use with a machine for preparing a beverage and/or foodstuff or a precursor thereof, the container including:
a storage portion comprising a cavity with a base for containing a precursor material, and;
a closing member to close the storage portion,
at least a base region of the storage portion is formed of a wood pulp based material, and
wherein the storage portion includes stiffener portions, which are arranged to stiffen the base to resist displacement when the base is perforated by a penetrator of the machine.

2. The container of claim 1, wherein the storage portion includes a side wall and the base region comprise the base and a proximal region of the sidewall,
the stiffener portions are arranged to extend over both the base and the proximal region of the side wall.

3. The container of claim 1, wherein the stiffener portions protrude into an interior of the storage portion and not outwardly from an exterior.

4. The container of claim 1, wherein the stiffener portions are arranged as channels that bridge the base and proximal region of the side wall.

5. The container of claim 4, wherein a base of the channels is linear.

6. The container of claim 4, wherein the stiffener portions have a maximum depth (X) of less than 10 mm and greater than 2 mm.

7. The container of claim 2, wherein the stiffener portions are arranged to extend in a depth direction along the sidewall from a junction with the base to a distance (Y) of less than 40% of a total depth D between the storage portion and base.

8. The container of claim 2, wherein the stiffener portions are arranged to extend along the base from a periphery to a radii of greater than 30% of the total diameter of the base.

9. The container of claim 2, wherein the stiffener portions are arranged to extend along the base from a periphery to contiguous a perforation region that is perforated by the penetrator of the machine.

10. The container of claim 1, wherein the stiffener portions are arranged to prevent a perforation region of the base displacing by more than 0.5-2 mm in a depth direction, when the perforation region is subject to a compressive force in the depth direction of 1-50 N, which is applied by the penetrator.

11. The container of claim 1, wherein the wood pulp-based material has a thickness of 0.25 mm to 0.75 mm and comprises wood pulp.

12. The container of claim 1, wherein the stiffener portions comprise discrete units that are circumferentially disposed about a circumference of the container.

13. A system comprising a container for use with a machine for preparing a beverage and/or foodstuff or a precursor thereof, the container including:
a storage portion comprising a cavity with a base for containing a precursor material, and;
a closing member to close the storage portion,
at least a base region of the storage portion is formed of a wood pulp based material, and
wherein the storage portion includes stiffener portions, which are arranged to stiffen the base to resist displacement when the base is perforated by a penetrator of the machine and a machine for preparing a beverage and/or foodstuff or a precursor thereof,
the machine including:
a processing unit for processing the precursor material of the container, and;
electrical circuitry to control the processing unit.

14. (canceled)

15. A method of preparing a beverage and/or foodstuff or a precursor thereof, the method comprising:
penetrating a wood pulp based portion of a container with a penetrator to provide fluid inlets and resisting displacement of the wood pulp based portion during said penetration with stiffener portions, and;
transmitting fluid into the container via the fluid inlets.
